(19) United States
(12) Patent Application Publication
(10) Pub. No.: US 2020/0174470 A1
(43) Pub. Date: Jun. 4, 2020

(54) SYSTEM AND METHOD FOR SUPPORTING AUTONOMOUS VEHICLE

(71) Applicants: HYUNDAI MOTOR COMPANY, Seoul (KR); KIA MOTORS CORPORATION, Seoul (KR)

(72) Inventors: Kang Won PARK, Seoul (KR); Tae Hyun SUNG, Seoul (KR)

(21) Appl. No.: 16/377,655

(22) Filed: Apr. 8, 2019

(30) Foreign Application Priority Data
Dec. 3, 2018 (KR) 10-2018-0153948

(51) Int. Cl. G05D 1/00; G08G 1/0968; G08G 1/0967; G05D 1/02

(52) U.S. Cl. CPC G05D 1/0061; G08G 1/096816; G05D 2201/0213; G05D 1/0276; G08G 1/096725

(57) ABSTRACT

A system for supporting an autonomous vehicle includes a server configured to search for and provide a driving route in response to a request of the vehicle; a controller configured to perform autonomous driving based on a road autonomous driving level included in the driving route, identify whether a change condition of a vehicle autonomous driving level is met, and adjust the vehicle autonomous driving level when the change condition of the vehicle autonomous driving level is met.

### CROSS-REFERENCE TO RELATED APPLICATION

This application is claims the benefit of priority to Korean Patent Application No. 10-2018-0153948, filed in the Korean Intellectual Property Office on Dec. 3, 2018, the entire contents of which are incorporated herein by reference.

### TECHNICAL FIELD

The present disclosure relates to a system and a method for supporting driving of an autonomous vehicle.

### BACKGROUND

An autonomous vehicle is a vehicle that can recognize the driving environment without operation by a driver, determine a danger, plan a driving route, and travel autonomously. The level of automation of such an autonomous vehicle is in general classified into six levels, from level 0 to level 5, according to guidelines (J3016) provided by the Society of Automotive Engineers (SAE).

In recent years, vehicle manufacturers have released vehicles with functions up to autonomous driving level 2, and have been making efforts to implement a limited-autonomous vehicle (level 3) capable of autonomous driving in a specific road environment such as a highway, a parking lot, and the like. In addition, to overcome the limitations of technology of recognizing driving environment such as road and traffic situations, and the like, research on an operation system cooperating with a vehicle and a road system to cope with the road situation in real time has continued.

### SUMMARY

The present disclosure has been made to solve the above-mentioned problems occurring in the prior art while advantages achieved by the prior art are maintained intact.

An aspect of the present disclosure provides a system for supporting an autonomous vehicle, which is capable of collecting autonomous driving state information from autonomous vehicles, calculating an autonomous driving level for each road section, and constructing road information by reflecting the calculated autonomous driving levels for each road section to provide the autonomous vehicle with the road information, and a method thereof.

In addition, another aspect of the present disclosure provides a system for supporting an autonomous vehicle, which is capable of searching for and providing a driving route in consideration of an autonomous driving level supported by a corresponding vehicle when the route search for the autonomous vehicle is requested, and a method thereof.

In addition, still another aspect of the present disclosure provides an autonomous vehicle which is capable of performing autonomous driving based on road information on which an autonomous driving level for each road section is reflected, and adjusting the autonomous driving level thereof based on whether the autonomous driving level thereof is different from the autonomous driving level of a driving road.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a system for supporting an autonomous vehicle may comprise: a server configured to search for and provide a driving route in response to a request of the vehicle; a controller configured to perform autonomous driving based on a road autonomous driving level included in the driving route, identify whether a change condition of a vehicle autonomous driving level is met, and adjust the vehicle autonomous driving level when the change condition of the vehicle autonomous driving level is met.

The server may collect vehicle autonomous driving state information including a vehicle location and the vehicle autonomous driving level from at least one vehicle able to perform the autonomous driving, and determine an autonomous driving level of each road section based on the collected vehicle autonomous driving state information.

The server may search for the driving route based on an autonomous driving support level included in vehicle autonomous driving state information transmitted after the vehicle starts.

The controller may determine whether the change condition is met based on whether the autonomous driving is released.

The controller may initialize the vehicle autonomous driving level when the autonomous driving is released.

The controller may identify whether the vehicle autonomous driving level and the road autonomous driving level are different from each other by a reference level or more.

The controller may output a warning when the vehicle autonomous driving level is greater than the road autonomous driving level.

The controller may adjust the vehicle autonomous driving level to the road autonomous driving level when the vehicle autonomous driving level is greater than the road autonomous driving level.

The controller may adjust the vehicle autonomous driving level to the road autonomous driving level when the vehicle autonomous driving level is less than the road autonomous driving level and a vehicle autonomous driving support level is greater than or equal to the road autonomous driving level.

The controller may output a notification informing of a change in the vehicle autonomous driving level.

According to another aspect of the present disclosure, a method of supporting an autonomous vehicle may comprise steps of: transmitting, by a controller, vehicle autonomous driving state information to a server and requesting a route search; receiving, by the controller, a driving route found by the server; performing, by the controller, the autonomous driving based on a road autonomous driving level included in the driving route; identifying, by the controller, whether a change condition of a vehicle autonomous driving level is met while performing the autonomous driving; and adjusting, by the controller, the vehicle autonomous driving level when the change condition is met.

The method may further include collecting, by the server, vehicle autonomous driving state information from at least one vehicle able to perform the autonomous driving, and determining an autonomous driving level of each road section based on the collected vehicle autonomous driving state information before the requesting of the route search.

The requesting of the route search may include transmitting, by the vehicle, vehicle autonomous driving state information including location information and an autonomous driving support level of the vehicle after the vehicle starts, searching, by the server, for the driving route based on the autonomous driving support level, and transmitting, by the server, the driving route to the vehicle.

The identifying of whether the change condition of the autonomous driving level is met may include identifying, by the vehicle, whether the autonomous driving is released.

The adjusting of the vehicle autonomous driving level may include initializing, by the vehicle, the vehicle autonomous driving level when the autonomous driving is released.

The identifying of whether the change condition of the autonomous driving level is met may include identifying, by the vehicle, whether the vehicle autonomous driving level and the road autonomous driving level are different from each other by a reference level or more.

The identifying of whether the change condition of the autonomous driving level is met may include outputting, by the vehicle, a warning when the vehicle autonomous driving level is greater than the road autonomous driving level.

The adjusting of the vehicle autonomous driving level may include adjusting, by the vehicle, the vehicle autonomous driving level to the road autonomous driving level when the vehicle autonomous driving level is greater than the road autonomous driving level.

The adjusting of the vehicle autonomous driving level may include adjusting, by the vehicle, the vehicle autonomous driving level to the road autonomous driving level when the vehicle autonomous driving level is less than the road autonomous driving level and a vehicle autonomous driving support level is greater than or equal to the road autonomous driving level.

The method may further include outputting, by the vehicle, a notification informing of a change in the vehicle autonomous driving level after the adjusting of the vehicle autonomous driving level.

According to still another aspect of the present disclosure, an autonomous vehicle includes a communication device that performs communication with a server, and a controller that performs an autonomous driving based on a road autonomous driving level included in a driving route provided from the server, identify whether a change condition of a vehicle autonomous driving level is met, and adjust the vehicle autonomous driving level when the change condition of the vehicle autonomous driving level is met.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a system for supporting an autonomous vehicle according to an embodiment of the present disclosure;

FIG. 2 is a block diagram illustrating an autonomous vehicle according to an embodiment of the present disclosure;

FIG. 3 is a flowchart illustrating a method of constructing autonomous driving support road information according to an embodiment of the present disclosure;

FIG. 4 is a flowchart illustrating a method of supporting an autonomous vehicle according to an embodiment of the present disclosure;

FIG. 5 is a view illustrating a screen for outputting a vehicle autonomous driving level warning according to an embodiment of the present disclosure;

FIG. 6 is a diagram illustrating a screen for outputting a notification of a vehicle autonomous-driving-level change according to an embodiment of the present disclosure;

FIGS. 7 and 8 are views illustrating a screen for outputting a route search result according to an embodiment of the present disclosure; and

FIG. 9 is a block diagram illustrating a computer system for executing a method of supporting an autonomous vehicle according to an embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the present disclosure, terms like first, second, “A”, “B”, (a), and (b) may be used. These terms are intended solely to distinguish one component from another, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

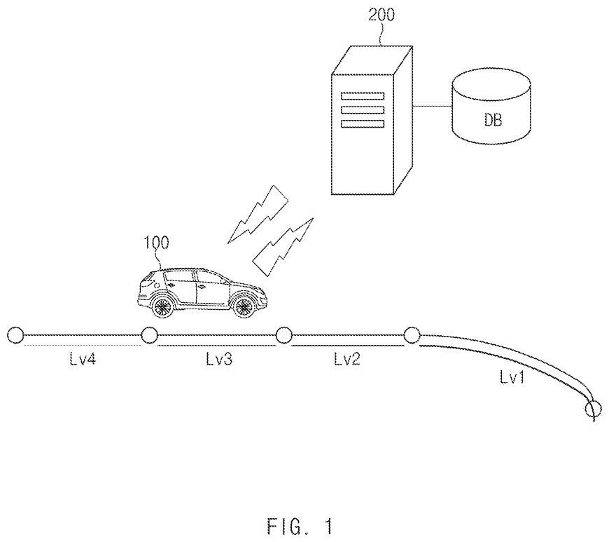

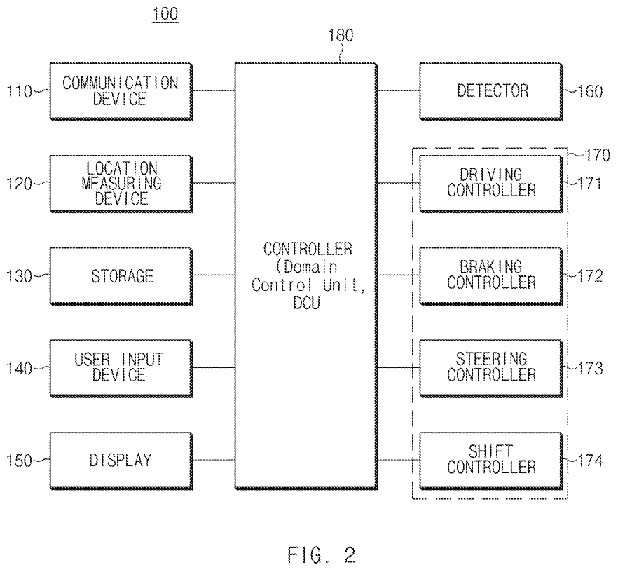

FIG. 1 is a view illustrating a system for supporting an autonomous vehicle according to an embodiment of the present disclosure. FIG. 2 is a block diagram illustrating an autonomous vehicle according to an embodiment of the present disclosure.

As shown in FIG. 1, a system for supporting an autonomous vehicle includes a vehicle 100 and a server 200.

The vehicle 100 is a vehicle capable of autonomous driving. The vehicle 100 transmits autonomous driving state information of the vehicle 100 to the server 200 in real time during traveling. In addition, the vehicle 100 adjusts an autonomous driving level of the vehicle 100 based on autonomous driving support information (e.g., a driving route, map information, road information, and the like) transmitted from the server 200.

As shown in FIG. 2, the vehicle 100 includes a communication device 110, a location measuring device 120, storage 130, a user input device 140, a display 150, a detector 160, a vehicle controller 170, and a controller 180.

The communication device 110 performs communication with the server 200. The communication device 110 may communicate with surrounding vehicles and/or a road infrastructure as well as the server 200. The communication device 110 may use a communication technology such as wireless Internet, mobile communication, vehicle-to-everything (V2X), or the like. Wireless LAN (WiFi), wireless broadband (Wibro), world interoperability for microwave access (Wimax), or the like may be used as the wireless Internet technology. As the mobile communication technology, code division multiple access (CDMA), global system for mobile communication (GSM), long term evolution (LTE), LTE-Advanced may be used. As the V2X communication technology, vehicle-to-vehicle (V2V), vehicle-to-infrastructure (V2I), vehicle-to-nomadic devices (V2N), in-vehicle network (IVN), or the like may be applied.

The location measuring device 120 measures the current location of a vehicle. The location measuring device 120 may measure the vehicle location by using at least one of location measuring techniques such as global positioning system (GPS), dead reckoning (DR), differential GPS (DGPS), carrier phase differential GPS, and the like.

The storage 130 may store software programmed for the controller 180 to perform a specified operation, and may store input/output data. In addition, the storage 130 may store a precise map in the form of a database. The precise map may be updated automatically at a specified transmission period or manually updated by a user. In addition, the storage 130 may store map information and road information mapped to the driving route provided from the server 200. The map information includes a precise map and road information. The road information includes information about an autonomous driving level for each road section (link), a road attribute, a traffic signal, a traffic situation, a road situation, a traffic sign, a main building, a surrounding vehicle driving situation, and the like.

The storage 130 may store vehicle identification information and a maximum autonomous driving level (autonomous driving support level) that the vehicle can support. The storage 130 may store a reliability calculation algorithm and software programmed to perform a specific control function for performing the autonomous driving of a vehicle.

The storage 130 may be implemented with at least one storage medium of storage mediums such as a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, a web storage, and the like.

The user input device 140 generates input data (e.g., an autonomous drive mode operation or a release) in response to a user's operation. The user input device 140 may be implemented with a keyboard, a keypad, a button, a switch, a touch pad, a touch screen, or the like. For example, the user input device 140 generates a signal of instructing a specific control function (e.g., lane keeping, obstacle avoidance, collision avoidance, lane change, acceleration/deceleration control, and the like) to be activated in response to a user input.

The display 150 displays a progress state and a result of the operation of the controller 180 in the form of visual information. The display 150 may include at least one of a liquid crystal display (LCD), a thin film transistor liquid crystal display (TFT LCD), an organic light-emitting diode (OLED) display, a flexible display, a 3D display, a transparent display, a head-up display (HUD), a touch screen, and a cluster.

The display 150 may include an acoustic output module such as a speaker capable of outputting audio data and a haptic signal output module (e.g., a vibrator). For example, the display 150 may display a message indicating that the current autonomous driving level is different from the autonomous driving level of the road on which the vehicle is traveling, and may also output a voice signal (audio signal) through a speaker.

In addition, the display 150 may be implemented with a touch screen coupled with a touch sensor, and may be used as an input device as well as an output device. As the touch sensor, a touch film, a touch pad, or the like may be used.

The detector 160 detects driving environment information of a road on which the vehicle travels and vehicle state information. The detector 160 acquires the driving environment information through various sensors such as a camera, a radio detecting and ranging (radar), a light detection and ranging (LiDAR), an ultrasonic sensor, and the like.

The detector 160 extracts shape information such as a lane, a speed limit, a traffic sign, a surrounding vehicle, a pedestrian, and a traffic light and distance information from the image information obtained through the camera. In addition, the detector 160 may obtain the distance and spatial information of an omnidirectional object (a vehicle, a pedestrian, an obstacle, or the like) through the radar, the LiDAR, and the ultrasonic sensor.

The detector 160 acquires vehicle information from one or more sensors and/or an electronic control unit (ECU) mounted on the vehicle. The one or more sensors may include an impact sensor, a velocity sensor, a steering angle sensor, and an acceleration sensor. The detector 160 may acquire vehicle information (e.g., airbag deployment, door opening, door close, and the like) from various electronic control units (ECUs) connected via the IVN. The IVN is implemented as a Controller Area Network (CAN), a Media Oriented Systems Transport (MOST) network, a Local Interconnect Network (LIN), and/or an X-by-Wire (Flexray).

The vehicle controller 170 controls steering, acceleration/deceleration, and/or braking of the vehicle in response to a command transmitted from the controller 180. The vehicle controller 170 includes a driving controller 171, a braking controller 172, a steering controller 173 and a shift controller 174.

The driving controller 171, which is an apparatus for controlling an engine of a vehicle, controls the acceleration of a vehicle. The driving controller 171 is implemented as an engine management system (EMS). The driving controller 171 controls the driving torque of the engine based on the accelerator pedal position information. In addition, the driving controller 171 controls the engine output to follow the target driving torque requested from the controller 180.

The braking controller 172 controls the deceleration of the vehicle. The braking controller 172 controls the braking pressure based on the position of the brake pedal or under the control of the controller 180.

The steering controller 173, which controls the steering of the vehicle, is implemented with motor drive power steering (MDPS). The steering controller 173 controls the steering angle of the vehicle under the control of the controller 180.

The shift controller 174 performs a function of shifting the gear (transmission) of the vehicle. The shift controller 174 is implemented with an electronic shifter or a shift-by-wire (SBW).

The controller 180 controls the vehicle controller 170 based on the driving environment information and the vehicle state information detected by the detector 160 to control the operation (steering, acceleration/deceleration, and/or braking) of the vehicle. The controller 180 may be implemented with at least one of an application specific integrated circuit (ASIC), a digital signal processor (DSP), a programmable logic device (PLD), a field programmable gate array (FPGA), a central processing unit (CPU), a microcontroller, and a microprocessor.

The controller 180 may include at least one specific control function corresponding to the autonomous driving support level (support level) of the vehicle. The specific control function may include smart cruise control (SCC), advanced smart cruise control (ASCC), navigation smart cruise control (NSCC), electronic stability control (ESC) lane departure warning (LDW), lane keeping assist (LKA), collision avoidance (CAS), driver status monitoring (DSM), highway driving assist (HDA), blind spot detection (BSD), autonomous emergency braking (AEB), traffic jam assist (TJA), and the like.

The controller 180 transmits the vehicle autonomous driving state information to the server 200 through the communication device 110 after the vehicle starts. The vehicle autonomous driving state information may include vehicle identification information, an autonomous driving support level, a current autonomous driving level (vehicle autonomous driving level), an operation control function (an activated control function), a vehicle location, whether the autonomous driving level is changed, reason for level change, and the like. In this case, the autonomous driving support level, which is a level of driving automation of the vehicle 100, is the maximum autonomous driving level that the vehicle 100 may support.

When the destination is set, the controller 180 may request the server 200 for route search. The controller 180 may transmit the autonomous driving support level of the vehicle together with the request for route search. Meanwhile, the controller 180 may perform the route search by using the map information stored in the storage 130.

The controller 180 receives the information about the driving route to the destination from the server 200 and starts the autonomous driving. The driving route information searched by the server 200 includes road information including map information and an autonomous driving level for each road section (link).

The controller 180 may set the current autonomous driving level of the vehicle to a preset autonomous driving level (default level) or an autonomous driving level of the road section mapped to the current location of the vehicle when the autonomous driving starts.

The controller 180 activates at least one specific control function corresponding to the current autonomous driving level of the vehicle to perform the corresponding control function. For example, when the current autonomous driving level of the vehicle is level 2, the SCC and LKA functions are activated. The controller 180 transmits a command to the vehicle controller 170 based on the determination result of the activated specific control function.

The controller 180 identifies whether the autonomous driving is released. The controller 180 releases the autonomous driving mode when it is impossible to maintain the autonomous driving due to an error of the specific control function, non-recognition of driving environment, accident occurrence in front of the vehicle, accident occurrence of the vehicle, or the like.

The controller 180 performs the autonomous driving and identifies whether the current autonomous driving level of the vehicle 100 is different from the road autonomous driving level. The road autonomous driving level, which is an autonomous driving level that is executable in a road section, refers to an autonomous driving level of each road section. That is, the controller 180 outputs a notification to the display 150 when the current autonomous driving level of the vehicle 100 is different from the autonomous driving level of the road section (link) on which the vehicle 100 is travelling.

When the current autonomous driving level of the vehicle is higher than the road autonomous driving level, the controller 180 adjusts the vehicle autonomous driving level downward. In addition, the controller 180 adjusts the autonomous driving level of the vehicle upward when the current autonomous driving level of the vehicle is lower than the road autonomous driving level. In this case, only when the road autonomous driving level is equal to or lower than the vehicle autonomous driving support level, the autonomous driving level of the vehicle is adjusted upward.

When an event such as the adjustment of the vehicle autonomous driving level, or the release of the autonomous driving of the vehicle 100 occurs, the controller 180 transmits the vehicle autonomous driving state information to the server 200 to notify that the autonomous driving level of the vehicle is changed. In this case, the controller 180 notifies the server 200 together of the reason why the autonomous driving level is changed.

The server 200 may be implemented with a cooperative ITS (C-ITS), an autonomous ITS (A-ITS), or the like as an intelligent transportation system (ITS) that constructs and provides information on roads for supporting autonomous driving. The server 200 stores and manages map information including road information in a database (DB).

The server 200 may collect vehicle information (road information, driver state information, and the like collected by an in-vehicle sensor), road information (status information about a road, a lane, a sudden obstacle, a road assistance facility, and the like), traffic information (individual vehicle driving state information, traffic situation information for each road section, and the like), climate information, and the like in real time through at least one vehicle 100 capable of performing autonomous driving, a roadside infrastructure installed at a roadside, and the like.

The server 200 receives the autonomous driving state information from at least one vehicle 100 which is autonomous driving. The server 200 maps the received autonomous driving state information to map information to calculate an autonomous driving level and reliability for each road section. The server 200 maps the road section (link) on which the vehicle 100 travels onto the map based on the vehicle location included in the autonomous driving state information, and identifies the current autonomous driving level of the vehicle 100. The server 200 maintains the current autonomous driving level of the vehicle 100 and monitors whether the vehicle 100 travels in the mapped road section. The server 200 evaluates the reliability of each road section based on the monitoring result.

The server 200 may calculate the reliability by using a reliability calculation algorithm. The server 200 maintains a specific autonomous driving level higher than the autonomous driving level of the road section and increases the reliability of the corresponding road section by a specified value (%) when the number of vehicles that travel stably is equal to or larger than the set number of vehicles. The server 200 reduces the reliability of a specific road section by a specified value (%) when the set number of vehicles that are traveling in the corresponding road section at a specific autonomous driving level release the autonomous driving mode. Alternatively, the server 200 subtracts the reliability of a specific road section by a specified value corresponding to the autonomous driving level of the vehicle in which an accident occurs during autonomous driving on the specific road.

For example, when a total of ten vehicles are maintained at autonomous driving level 3 in a specific road section without any particular reason, the server 200 increases the reliability of the corresponding road section by 20%. When two vehicles traveling at level 4 release the autonomous driving mode, the server 200 reduces the reliability of the corresponding road section by 10%. When an accident occurs in the vehicle traveling at level 4 in a specific road section, the server 200 changes (initializes) the reliability of the corresponding road section to 10%.

The server 200 may calculate the reliability based on information about the autonomous driving levels of vehicles 100 travelling in each road section, the number of vehicles that release the autonomous driving mode, information about an autonomous driving level change of a vehicle, the autonomous driving level of an accident vehicle at the time of the accident, a difference between real road information collected by the vehicle 100 and road information stored in a DB, a vehicle type, weather, a time zone, and the like, and may assign the autonomous driving level based on the corresponding reliability. For example, the server 200 may give an autonomous driving level corresponding to the reliability as shown in Table 1.

TABLE 1

| Autonomous driving level | Reliability |
|---|---|
| Lv 4 | 95% |
| Lv 3 | 75% |
| Lv 2 | 50% |
| Lv 1 | 20% |

The server 200 updates the autonomous driving level for each road section based on the data collected in real time to construct the road information. When the server 200 receives the route search request from the vehicle 100, the server 200 searches for the driving route in consideration of the autonomous driving support level of the vehicle 100. For example, when the autonomous driving support level of the vehicle 100 is level 3, the server 200 searches for a driving route in which the vehicle 100 travels only below level 3. In addition, when the target autonomous driving level and the specific requirement are received from the vehicle 100, the server 200 searches for the driving route based on the target autonomous driving level and the specific requirement. In this case, the server 200 may search for a driving route including road sections, in which the vehicle can travel at a target autonomous driving level, at a specified ratio or more. In addition, the server 200 may search for a driving route including road sections that meet the requirements to the maximum. The server 200 transmits the searched driving route to the vehicle 100.

Although not shown, the server 200 includes a communication module for communicating with the vehicle 100, a processor for controlling the overall operation of the server 200, and a memory for storing software programmed to perform a specified operation instructed by the processor.

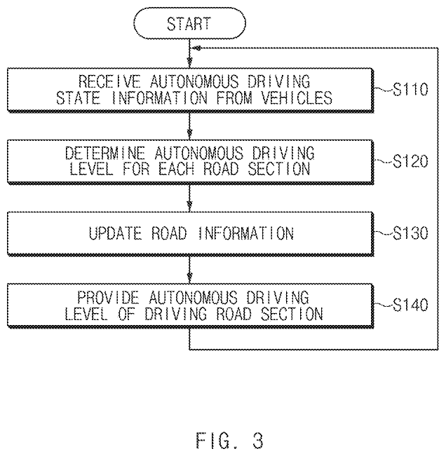

FIG. 3 is a flowchart illustrating a method of constructing autonomous driving support road information according to an embodiment of the present disclosure.

In operation S110, the server 200 receives the autonomous driving state information from at least one vehicle 100 capable of performing autonomous driving. The autonomous driving state information may include vehicle identification information, an autonomous driving support level, a current autonomous driving level, an operation control function, a vehicle location, information about whether an autonomous driving level is changed, level change reason, and the like.

In operation S120, the server 200 determines an autonomous driving level for each road section based on the received autonomous driving state information. The server 200 matches the road section onto the map based on the vehicle location included in the autonomous driving state information, and calculates the reliability of the matched road section in consideration of the current autonomous driving level. The server 200 determines the autonomous driving level of the corresponding road section based on the calculated reliability of the road section.

In operation S130, the server 200 updates the road information by reflecting the determined autonomous driving level for each road section. That is, the server 200 updates the autonomous driving level for each road section to construct the road information.

In operation S140, the server 200 provides the autonomous driving level of the driving road section to each vehicle based on the updated road information. For example, when the autonomous driving level of a specific road section is changed, the server 200 transmits the changed autonomous driving level of road to the vehicles 100 that are travelling on the corresponding road section.

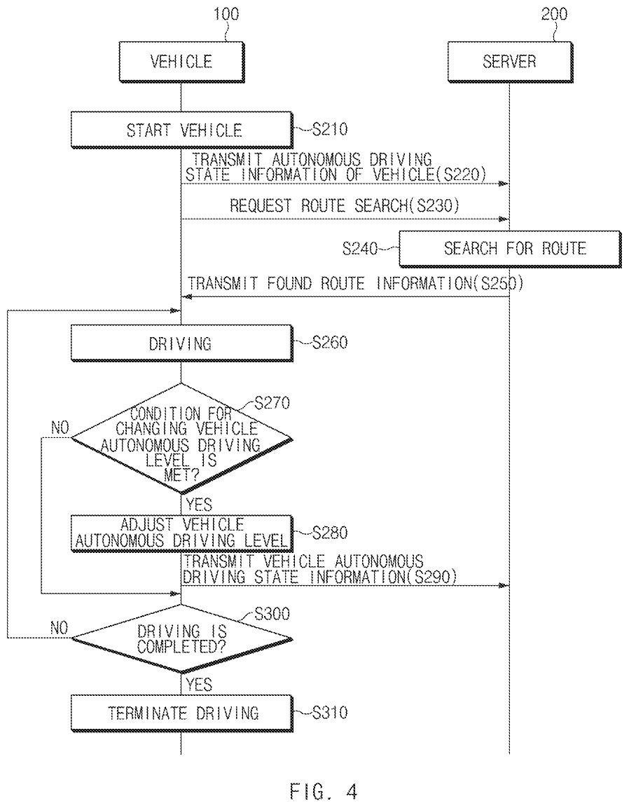

FIG. 4 is a flowchart illustrating a method of supporting an autonomous vehicle according to an embodiment of the present disclosure.

After the vehicle 100 is started in operation S210, the vehicle 100 transmits the autonomous driving state information thereof to the server 200 in operation S220. The autonomous driving state information may include vehicle identification information, an autonomous driving support level, a current autonomous driving level (vehicle autonomous driving level), an operation control function, a vehicle location, information about whether an autonomous driving level is changed, level change reason, and the like.

Then, in operation S230, when the destination is set, the vehicle 100 requests the server 200 for a route search from the current location of the vehicle to the destination. The vehicle 100 may also transmit the vehicle autonomous driving support level information together when requesting the route search.

In operation S240, the server 200 searches for the driving route to the destination in response to the route search request of the vehicle 100. The server 200 searches for the driving route in consideration of the vehicle autonomous driving support level.

In operation S250, the server 200 transmits the found driving route to the vehicle 100.

In operation S260, the vehicle 100 performs autonomous driving based on the driving route provided from the server 200.

In operation S270, the vehicle 100 identifies whether the condition for changing the vehicle autonomous driving level is met while autonomous driving. The vehicle 100 may determine whether the level change condition is met based on whether the autonomous driving of the vehicle 100 is released. For example, the vehicle 100 determines that the level change condition is met when the autonomous driving release is determined due to an accident or an unexpected occurrence during autonomous driving, or when the autonomous driving release command is received from the user input device 140. In addition, the vehicle 100 determines whether the changing conditions of the vehicle autonomous driving level is met based on whether the vehicle autonomous driving level is different from the road autonomous driving level. The vehicle 100 determines that the level change condition is met when the difference between the vehicle autonomous driving level and the road autonomous driving level is equal to or higher than a preset reference (e.g., level 2).

In operation S280, when the level change condition is met, the vehicle 100 adjusts the vehicle autonomous driving level. When the vehicle autonomous driving level is higher than the road autonomous driving level, the vehicle 100 may adjust the vehicle autonomous driving level to the road autonomous driving level. The vehicle 100 may adjust the vehicle autonomous driving level to the road autonomous driving level when the vehicle autonomous driving level is lower than the road autonomous driving level and the road autonomous driving level is equal to or lower than the vehicle autonomous driving support level. When the autonomous driving is released, the vehicle 100 may initialize the vehicle autonomous driving level (level 1).

In operation S290, when the vehicle autonomous driving level is adjusted, the vehicle 100 transmits the vehicle autonomous driving state information to the server 200. When the current autonomous driving level of the vehicle 100 is changed, the vehicle 100 transmits to the server 200 the vehicle autonomous driving state information including information about the changed current autonomous driving level and the reason for change.

In operation S300, after transmitting the vehicle autonomous driving state information, the vehicle 100 identifies whether the driving is completed. In operation S310, when the driving is completed, the vehicle 100 terminates the autonomous driving. When the vehicle location and the destination coincide with each other within the error range, the vehicle 100 determines that the driving is completed.

When the driving is not completed, in operation S260, the vehicle 100 maintains the autonomous driving.

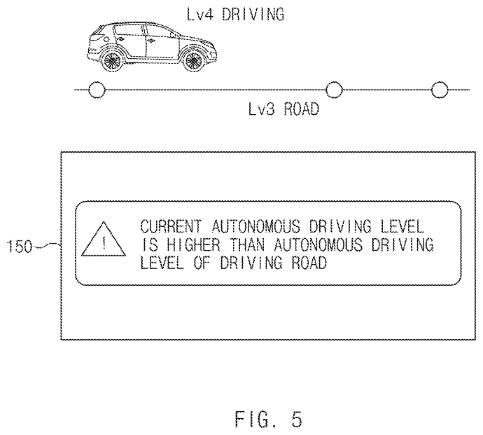

FIG. 5 is a view illustrating a screen for outputting a vehicle autonomous driving level warning according to an embodiment of the present disclosure.

As shown in FIG. 5, when the current autonomous driving level is level 4 (Lv 4) and the autonomous driving level of the road section on which the vehicle 100 is running is level 3 (Lv 3), the vehicle 100 outputs a warning indicating that the present autonomous driving level is higher than the autonomous driving level of the road section. The vehicle 100 outputs a warning message to the display 150, such as “Current autonomous driving level is higher than autonomous driving level of driving road.”

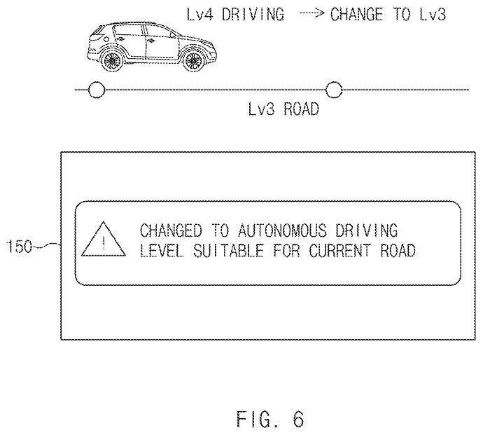

FIG. 6 is a diagram illustrating a screen for outputting a notification of a vehicle autonomous-driving-level change according to an embodiment of the present disclosure.

Referring to FIG. 6, when the current autonomous driving level is level 4 (Lv 4) and the autonomous driving level of the road section in which the vehicle 100 is traveling is level 3 (Lv 3), the vehicle 100 adjusts the vehicle autonomous driving level from level 4 to level 3. The vehicle 100 outputs, to the display 150, a notification message such as “Changed to an autonomous driving level suitable for the current road” for notifying that the vehicle autonomous driving level is changed.

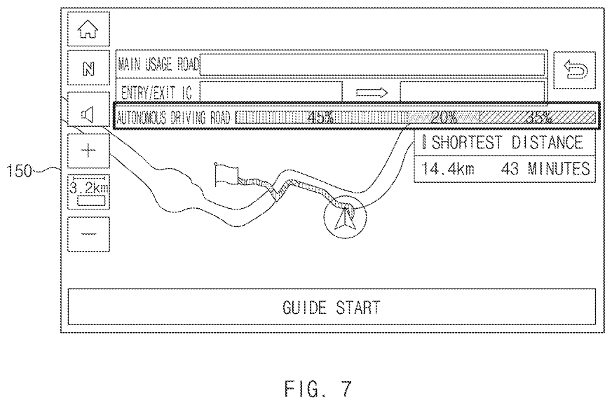

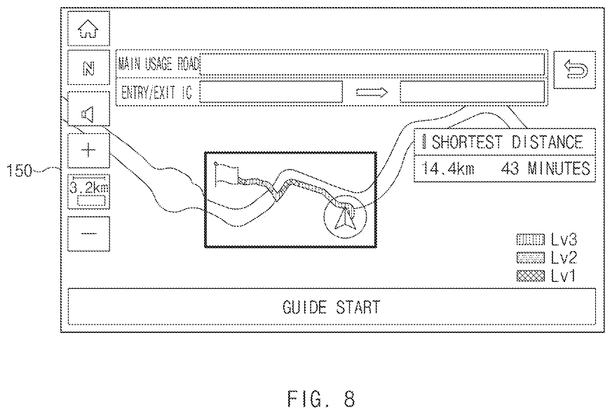

FIGS. 7 and 8 are views illustrating a screen for outputting a route search result according to an embodiment of the present disclosure.

The server 200 searches for a driving route at the request of the vehicle 100, and transmits the search result to the vehicle 100. The vehicle 100 displays the driving route provided from the server 200. In this case, the vehicle 100 may display a road section ratio for each autonomous driving level in the driving route. As shown in FIG. 7, when the road section capable of traveling at the autonomous driving level of ‘3’ in the driving route is 45%, the road section capable of traveling at the autonomous driving level of ‘2’ is 20%, and the road section capable of traveling at the autonomous driving level of ‘1’ is 35%, the vehicle 100 may display the color and the bar length differently corresponding to the autonomous driving level and the road section ratio.

In addition, the server 200 may perform the route search considering the autonomous driving support level of the vehicle 100, that is, the maximum autonomous driving level which the vehicle may support. For example, when the autonomous driving support level of the vehicle 100 is level 3, the server 200 searches for and provides a driving route composed only of road sections having road autonomous driving levels of level 1 to 3. Thus, as shown in FIG. 8, the vehicle 100 guides the driving route including only road sections in which the vehicle performs the autonomous driving.

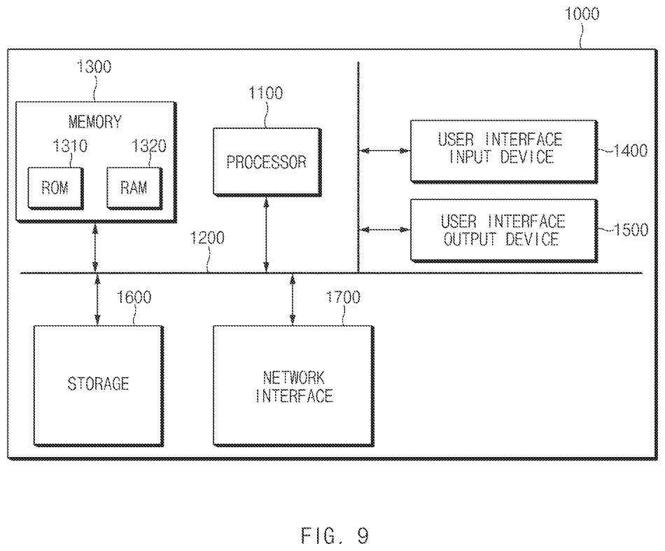

FIG. 9 is a block diagram illustrating a computer system for executing a method of supporting an autonomous vehicle according to an embodiment of the present disclosure.

Referring to FIG. 9, a computing system 1000 may include at least one processor 1100, a memory 1300, a user interface input device 1400, a user interface output device 1500, storage 1600, and a network interface 1700, which are connected to each other through a bus 1200.

The processor 1100 may be a central processing unit (CPU) or a semiconductor device which performs processing for instructions stored in the memory device 1300 and/or the storage 1600. The memory 1300 and the storage 1600 may include various types of volatile or non-volatile storage media. For example, the memory 1300 may include a read only memory (ROM) and a random access memory (RAM).

The operations of a method or algorithm described in connection with the embodiments disclosed herein may be embodied directly in hardware, in a software module executed by the processor 1100, or in a combination of the two. The software module may reside in a storage medium (that is, the memory 1300 and/or the storage 1600) such as a random access memory (RAM), a flash memory, a read only memory (ROM), an erasable programmable ROM (EPROM), an electrically erasable programmable ROM (EEPROM), registers, hard disk, a removable disk, a compact disc-ROM (CD-ROM), etc. An exemplary storage medium is coupled to the processor 1100 such that the processor 1100 may read information from, and write information to, the storage medium. Alternatively, the storage medium may be integrated into the processor 1100. The processor and the storage medium may reside in an ASIC. The ASIC may reside within a user terminal. Alternatively, the processor and the storage medium may reside in the user terminal as individual components.

According to the embodiments of the present disclosure, the autonomous driving state information may be collected by using an autonomous vehicle as a probe vehicle, the autonomous driving level for each road section may be calculated, and the road information is constructed by reflecting the calculated autonomous driving level for each road section to be provided to the autonomous vehicle, so that the vehicle may maintain autonomous driving more reliably.

In addition, according to the embodiments of the present disclosure, when the autonomous vehicle requests the route search, the driving route is searched and provided considering the autonomous driving level supported by the corresponding vehicle, thereby improving the utilization rate of autonomous driving.

In addition, according to the embodiments of the present disclosure, the autonomous driving is performed based on the road information on which the autonomous driving level for each road section is reflected, and the autonomous driving level of the vehicle is adjusted based on whether the autonomous driving level of the vehicle is different from the autonomous driving level of the driving road, thereby improving the driving safety of the autonomous vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system for supporting an autonomous vehicle, the system comprising:
a server configured to search for and provide a driving route in response to a request of the vehicle; and
a controller configured to:
perform autonomous driving based on a road autonomous driving level included in the driving route;
identify whether a change condition of a vehicle autonomous driving level is met; and
adjust the vehicle autonomous driving level when the change condition of the vehicle autonomous driving level is met.

2. The system of claim 1, wherein the server is configured to:
collect vehicle autonomous driving state information including a vehicle location and the vehicle autonomous driving level from at least one vehicle able to perform the autonomous driving; and
determine an autonomous driving level of each road section based on the collected vehicle autonomous driving state information.

3. The system of claim 1, wherein the server is configured to search for the driving route based on an autonomous driving support level included in vehicle autonomous driving state information transmitted after the autonomous vehicle starts.

4. The system of claim 1, wherein the controller is configured to determine whether the change condition is met based on whether the autonomous driving is released.

5. The system of claim 4, wherein the controller is configured to initialize the vehicle autonomous driving level when the autonomous driving is released.

6. The system of claim 1, wherein the controller is configured to identify whether the vehicle autonomous driving level and the road autonomous driving level are different from each other by a reference level or more.

7. The system of claim 6, wherein the controller is configured to output a warning when the vehicle autonomous driving level is greater than the road autonomous driving level.

8. The system of claim 6, wherein the controller is configured to adjust the vehicle autonomous driving level to the road autonomous driving level when the vehicle autonomous driving level is greater than the road autonomous driving level.

9. The system of claim 6, wherein the controller is configured to adjust the vehicle autonomous driving level to the road autonomous driving level when the vehicle autonomous driving level is less than the road autonomous driving level and a vehicle autonomous driving support level is greater than or equal to the road autonomous driving level.

10. The system of claim 9, wherein the controller is configured to output a notification informing of a change in the vehicle autonomous driving level.

11. A method of supporting an autonomous vehicle, the method comprising steps of:
transmitting, by a controller, vehicle autonomous driving state information to a server and requesting a route search;
receiving, by the controller, a driving route found by the server;
performing, by the controller, the autonomous driving based on a road autonomous driving level included in the driving route;
identifying, by the controller, whether a change condition of a vehicle autonomous driving level is met while performing the autonomous driving; and
adjusting, by the controller, the vehicle autonomous driving level when the change condition is met.

12. The method of claim 11, further comprising steps of:
collecting, by the server, vehicle autonomous driving state information from at least one vehicle able to perform the autonomous driving; and
determining, by the server, an autonomous driving level of each road section based on the collected vehicle autonomous driving state information before the requesting of the route search.

13. The method of claim 11, wherein the step of transmitting and requesting includes steps of:
transmitting, by the controller, vehicle autonomous driving state information including location information and an autonomous driving support level of the vehicle to the server after the autonomous vehicle starts;
searching, by the server, for the driving route based on the autonomous driving support level; and
transmitting, by the server, the driving route to the vehicle.

14. The method of claim 11, wherein the step of identifying whether the change condition of the autonomous driving level is met includes a step of:
identifying, by the controller, whether the autonomous driving is released.

15. The method of claim 14, wherein the step of adjusting the vehicle autonomous driving level includes a step of:
initializing, by the controller, the vehicle autonomous driving level when the autonomous driving is released.

16. The method of claim 11, wherein the step of identifying whether the change condition of the autonomous driving level is met includes a step of:
identifying, by the controller, whether the vehicle autonomous driving level and the road autonomous driving level are different from each other by a reference level or more.

17. The method of claim 16, wherein the step of identifying whether the change condition of the autonomous driving level is met further includes a step of:
outputting, by the controller, a warning when the vehicle autonomous driving level is greater than the road autonomous driving level.

18. The method of claim 16, wherein the step of adjusting the vehicle autonomous driving level includes a step of:
adjusting, by the controller, the vehicle autonomous driving level to the road autonomous driving level when the vehicle autonomous driving level is greater than the road autonomous driving level.

19. The method of claim 16, wherein the step of adjusting the vehicle autonomous driving level includes:
adjusting, by the controller, the vehicle autonomous driving level to the road autonomous driving level when the vehicle autonomous driving level is less than the road autonomous driving level and a vehicle autonomous driving support level is greater than or equal to the road autonomous driving level.

20. The method of claim 19, further comprising, after the step of adjusting the vehicle autonomous driving level, a step of:
outputting, by the controller, a notification informing of a change in the vehicle autonomous driving level.

21. An autonomous vehicle comprising:
a communication device configured to perform communication with a server; and
a controller configured to:
perform an autonomous driving based on a road autonomous driving level included in a driving route provided from the server;
identify whether a change condition of a vehicle autonomous driving level is met; and
adjust the vehicle autonomous driving level when the change condition of the vehicle autonomous driving level is met.

22. The system of claim 1, further comprising a vehicle, wherein the controller is installed in the vehicle.
